(19) United States
(12) Patent Application Publication
(10) Pub. No.: US 2024/0042407 A1
(43) Pub. Date: Feb. 8, 2024

(54) HEAT EXCHANGE REACTOR

(71) Applicant: Woodside Energy Technologies Pty Ltd, Perth, Western Australia (AU)

(72) Inventors: Solomon Aladja Faka, Salter Point, Western Australia (AU); Michael Edward Lev Massen-Hane, Perth, Western Australia (AU); Sui Boon Liaw, Maddington, Western Australia (AU)

(21) Appl. No.: 18/453,477

(22) Filed: Aug. 22, 2023

Related U.S. Application Data
(63) Continuation of application No. PCT/AU2022/050158, filed on Feb. 25, 2022.

(30) Foreign Application Priority Data
Feb. 25, 2021 (AU) 2021900521

(51) Int. Cl. B01J 8/06

(52) U.S. Cl. CPC B01J 8/067; B01J 2208/00221; B01J 2208/065; F28D 2021/0022

(57) ABSTRACT

A reactor includes a shell enveloping a reaction zone, a heat transfer zone, and an isolation zone. The shell is provided with a feed fluid inlet, a product fluid outlet, and an isolation fluid inlet. The reaction zone provides fluid communication between feed fluid inlet and product fluid outlet, and extends though the heat transfer zone and the isolation zone. The isolation zone is located between the heat transfer zone and the product fluid outlet, where a feed fluid, as it flows from the feed fluid inlet and through the reaction zone, is heated by a heat transfer fluid flowing through the heat transfer zone and reacts to form a product fluid that flows out of the shell through the product fluid outlet. A purge fluid in the isolation zone is at a positive pressure relative to a pressure of the heat transfer fluid flowing through the heat transfer zone.

### CROSS-REFERENCE TO RELATED APPLICATIONS

This application is a continuation of International Application No. PCT/AU2022/050158, filed Feb. 25, 2022, which claims priority from AU 2021900521, filed Feb. 25, 2021, the disclosures of which are incorporated herein by reference in their entireties.

### TECHNICAL FIELD

A heat exchange reactor is disclosed. The heat exchange reactor has particular, but not exclusive, application for the reforming of hydrocarbons to produce a product fluid or gas.

### BACKGROUND

One form of heat exchange reactor comprises a large vessel or shell made of metal and/or ceramic material. Tubes or pipes extend through the shell forming a feed gas flow path through the reactor. A region within the shell but exterior of the tubes forms a heat transfer zone. The interior volume of the tubes forms a reaction zone. The reaction zone side and the heat transfer zone are fluidically isolated from each other but in thermal communication. This allows a feed fluid (typically a gas) and a heat exchange medium to both flow simultaneously through the reactor physically separate from each other but with heat being transferred from the heat exchange medium to the feed gas. (Throughout this specification every use of the word “gas” is intended to be read as interchangeable with the word “fluid”.) A catalyst may be present in the tubes to facilitate or promote a desired reaction in the feed gas to produce a product gas. The product gas may include, but is not limited to, a synthesis gas in the case of steam methane reforming or bi-reforming.

The reactor may operate at temperatures in excess of 350° C. with a resultant product gas having a temperature in the order of 600° C. to 950° C. with reactions conducted at elevated pressure, 2-60 bara, which can be adjusted based on the downstream use of the product gas, for instance to 20-30 bara. As a result of this, there is substantial thermal expansion of the tubes within the reactor. The tubes in a reactor are often orientated to run vertically and pass through a boundary or wall at a lower end of the shell. This wall separates the heat exchanger zone from an outlet zone or manifold within the shell. Dynamic seals are provided about the tubes near the boundary wall to maintain a substantial fluid seal between the heat exchanger zone and the outlet zone. This minimises the risk of the product gas or fluid being contaminated or mixed with the heat exchange medium.

The above references to the background art do not constitute an admission that the art forms a part of the common general knowledge of a person of ordinary skill in the art. The above references are also not intended to limit the application of the reactor as disclosed herein.

### SUMMARY

In one embodiment of a first aspect there is disclosed a reactor comprising:
a shell enveloping: a reaction zone, a heat transfer zone, and an isolation zone;
the shell provided with: a feed fluid inlet, a product fluid outlet, and an isolation fluid inlet wherein the reaction zone provides fluid communication between the feed fluid inlet and the product fluid outlet, and extends though the heat transfer zone and the isolation zone; the isolation zone being located between the heat transfer zone and the product fluid outlet;
wherein a feed fluid as it flows from the feed fluid inlet, through the reaction zone is heated by a heat transfer fluid flowing through the heat transfer zone and reacts to form a product fluid that flows out of the shell through the product fluid outlet, and a purge fluid in the isolation zone is at a positive pressure relative to a pressure of the heat transfer fluid flowing through the heat transfer zone.

In some embodiments of the disclosure, there is provided a reactor. The reactor may comprise a shell enveloping: a reaction zone, a heat transfer zone, and an isolation zone. The shell may be provided with a feed fluid inlet, a product fluid outlet, and an isolation fluid inlet. The reaction zone may provide fluid communication between the feed fluid inlet and the product fluid outlet. The reaction zone may extend though the heat transfer zone and the isolation zone. The isolation zone may be located between the heat transfer zone and the product fluid outlet. The reactor may comprise a tube sheet that is connected to the shell, and that extends across an inside of the shell. The reactor may comprise a plurality of tubes that extend through the inside of the shell, each tube being connected to the tube sheet, and having an inlet opening in fluid communication with the feed fluid inlet and an outlet opening in fluid communication with the product fluid outlet. The reactor may comprise a first wall that is connected to the shell and that extends across the inside of the shell, the first wall defining a plurality of first wall openings, each first wall opening being configured to enable a tube of the plurality of tubes to extend through the first wall. The reactor may comprise a first seal that is connected to the first wall at one of the first wall openings. The first seal may be configured to contact the tube that extends through the respective first wall opening, to form a seal about that tube. The first seal may be configured to maintain the seal as a longitudinal dimension of the tube changes and the tube slides through the first seal. The reactor may comprise a second wall that is connected to the shell and that extends across the inside of the shell, the second wall defining a plurality of second wall openings, each second wall opening being configured to enable a tube of the plurality of tubes to extend through the second wall. The reactor may comprise a second seal that is connected to the second wall at one of the second wall openings. The second seal may be configured to contact the tube that extends through the respective second wall opening, to form a seal about that tube. The second seal may be configured to maintain the seal as a longitudinal dimension of the tube changes and the tube slides through the second seal. Each tube may extend away from the tube sheet, through the first wall and the second wall, to a free end. A collective interior volume of the tubes may make up the reaction zone. The reactor may be configured such that, in use, a feed fluid, as it flows from the feed fluid inlet, through the reaction zone, is heated by a heat transfer fluid flowing through the heat transfer zone, and reacts to form a product fluid that flows out of the shell through the product fluid outlet, and a purge fluid in the isolation zone is at a positive pressure relative to a pressure of the heat transfer fluid flowing through the heat transfer zone and the product gas at the product fluid outlet.

In some embodiments, the reactor comprises a sealing system forming a substantial fluid seal between the heat transfer zone and the product fluid outlet, wherein the reaction zone passes through the sealing system.

In some embodiments, the reaction zone comprises a plurality of tubes that extend through the heat transfer zone and the isolation zone, each tube having an inlet in fluid communication with the feed fluid inlet and an outlet in fluid communication with the product fluid outlet.

In some embodiments, the reaction zone comprises a plurality of tubes that extend through the sealing system.

In some embodiments, the sealing system comprises for each tube a first seal and a second seal, the first seal forming a substantial seal about a first part of that tube adjacent a first boundary between the isolation zone and the heat transfer zone, and the second seal forming a substantial seal about a part of that tube adjacent a second boundary between the isolation zone and the product fluid outlet.

In some embodiments, the sealing system is arranged to accommodate expansion and contraction of the tubes.

In some embodiments, the reactor comprises a catalyst disposed in the reaction zone.

In some embodiments, the reactor comprises an outlet zone within the shell and in fluid communication between the reaction zone and the product fluid outlet wherein the product gas flows from the reaction zone into the outlet zone prior to flowing out of the product fluid outlet.

In some embodiments, the purge in the isolation zone is at a positive pressure relative to pressure of the product gas in the outlet zone.

In some embodiments, the purge in the isolation zone is at a positive pressure relative to pressure of the product gas at the product fluid outlet.

In some embodiments, the reactor comprises a tube sheet that is connected to the shell, and that extends across an inside of the shell; and a plurality of tubes that extend through the inside of the shell, each tube being connected to the tube sheet, and having an inlet opening in fluid communication with the feed fluid inlet and an outlet opening in fluid communication with the product fluid outlet, wherein: each tube extends away from the tube sheet to a free end; and a collective interior volume of the tubes make up the reaction zone.

In some embodiments, the reactor comprises a first wall that is connected to the shell and that extends across the inside of the shell, the first wall defining a plurality of first wall openings, each first wall opening being configured to enable one of the plurality of tubes to extend through the first wall; and a second wall that is connected to the shell and that extends across the inside of the shell, the second wall defining a plurality of second wall openings, each second wall opening being configured to enable one of the plurality of tubes to extend through the second wall; wherein: the tube sheet is between the feed fluid inlet and the first wall; and the first wall is between the tube sheet and the second wall.

In some embodiments, the reactor comprises a sealing system comprising: a first seal that is connected to the first wall at one of the first wall openings, the first seal contacting the tube of the plurality of tubes that extends through the respective first wall opening to form a substantial seal about a first part of that tube; and a second seal that is connected to the second wall at one of the second wall openings, the second seal contacting the tube of the plurality of tubes that extends through the respective second wall opening to form a substantial seal about a second part of that tube.

In some embodiments, the first seal is exposed to the heat transfer zone and the isolation zone.

In some embodiments, the second seal is exposed to the isolation zone and the outlet zone.

In some embodiments, the inlet zone is defined, at least in part, by: a first end portion of the shell; and an upper surface of the tube sheet.

In some embodiments, the heat transfer zone is defined, at least in part, by: an intermediate portion of the shell; a lower surface of the tube sheet; an upper surface of the first wall; and a first portion of the first seal.

In some embodiments, the isolation zone is defined, at least in part, by: a second intermediate portion of the shell; a lower surface of the first wall; a second portion of the first seal; an upper surface of the second wall; and a first portion of the second seal.

In some embodiments, the outlet zone is defined, at least in part, by: a second end portion of the shell; a lower surface of the second wall; and a second portion of the second seal.

In some embodiments, the reactor comprises: a sensor that is configured to enable the measurement of a sensor parameter associated with the isolation zone; and a controller that is configured to determine process data using a value of the sensor parameter measured using the sensor.

In some embodiments, the controller is configured to transmit a signal in response to a process data value meeting a process criterion.

In some embodiments, the reactor comprises an isolation zone fluid outlet configured to enable fluid to exit the isolation zone.

In a second embodiment of a first aspect there is disclosed a reactor comprising:
a shell having a feed fluid inlet and a product fluid outlet;
a plurality of tubes located within the shell and providing fluid communication between the feed fluid inlet and the product fluid outlet;
a first boundary in the shell through which the tubes pass and located between the feed fluid inlet and product fluid outlet;
a second boundary in the shell through which the tubes pass and located between the first boundary and product fluid outlet; and
a sealing system forming a substantial seal between the tubes and each of the first and second boundaries.

In some embodiments, there is disclosed a reactor comprising: a shell having a feed fluid inlet and a product fluid outlet; a heating chamber within the shell having a heating fluid inlet and a heating fluid outlet; a plurality of tubes located within the shell and providing fluid communication between the feed fluid inlet and the product fluid outlet, the plurality of tubes extending through the heating chamber; a first boundary in the shell through which the tubes pass and located between the feed fluid inlet and product fluid outlet and forming one end of the heating chamber; a second boundary in the shell through which the tubes pass and located between the first boundary and the product fluid outlet, and on a side of the first boundary outside of the heating chamber; and a sealing system forming a substantial seal between the tubes and each of the first and second boundaries.

In some embodiments, there is provided a reactor. The reactor may comprise a shell having a feed fluid inlet and a product fluid outlet. The reactor may comprise a heating chamber within the shell having a heating fluid inlet and a heating fluid outlet. The reactor may comprise a plurality of tubes located within the shell and providing fluid communication between the feed fluid inlet and the product fluid outlet, the plurality of tubes extending through the heating chamber from a fixed end to a free end. The reactor may comprise a first boundary in the shell, through which the tubes pass, the first boundary being located between the feed fluid inlet and product fluid outlet and forming one end of the heating chamber. The reactor may comprise a second boundary in the shell, through which the tubes pass, the second boundary being located between the first boundary and the product fluid outlet, and on a side of the first boundary outside of the heating chamber. The reactor may comprise an isolation zone between the first boundary and the second boundary, through which the tubes pass, the isolation zone being configured to receive a purge fluid. The reactor may comprise a sealing system forming a seal between the tubes and each of the first and second boundaries. The sealing system may be configured to accommodate relative movement between the tubes, the first boundary and the second boundary where the sealing system engages the tubes.

In some embodiments, the sealing system comprises for each tube a first seal and a second seal, the first seal forming a substantial seal about a first part of that tube adjacent the first boundary, and the second seal forming a substantial seal about a part of that tube adjacent the second boundary.

In some embodiments, the reactor comprises a heat transfer zone fluidically sealed from and in thermal communication with the tubes, wherein heat from a fluid passing through the heat transfer zone is transferred to a feed fluid flowing through the tubes.

In some embodiments, the reactor comprises an isolation zone formed by and between the shell, the first and second boundaries and the tubes; and an isolation fluid inlet formed in the shell enabling a purge fluid to flow into the isolation zone.

In some embodiments, the reactor comprises a purge fluid in the isolation zone, the purge fluid being at a positive pressure relative to the heat transfer fluid.

In some embodiments, the purge fluid at a positive pressure relative to a product fluid leaving the shell at the product fluid outlet.

In some embodiments, the reactor comprises a tube sheet that is connected to the shell, and that extends across an inside of the shell; wherein each tube: is connected to the tube sheet; has an inlet opening in fluid communication with the feed fluid inlet and an outlet opening in fluid communication with the product fluid outlet; and extends away from the tube sheet to a free end.

In some embodiments, the first boundary comprises a first wall that is connected to the shell and that extends across the inside of the shell, the first wall defining a plurality of first wall openings, each first wall opening being configured to enable one of the plurality of tubes to extend through the first wall; the second boundary comprises a second wall that is connected to the shell and that extends across the inside of the shell, the second wall defining a plurality of second wall openings, each second wall opening being configured to enable one of the plurality of tubes to extend through the second wall; the tube sheet is between the feed fluid inlet and the first boundary; and the first boundary is between the tube sheet and the second boundary.

In some embodiments, the sealing system comprises: a first seal that is connected to the first wall at one of the first wall openings, the first seal contacting the tube of the plurality of tubes that extends through the respective first wall opening to form a substantial seal about a first part of that tube; and a second seal that is connected to the second wall at one of the second wall openings, the second seal contacting the tube of the plurality of tubes that extends through the respective second wall opening to form a substantial seal about a second part of that tube.

In some embodiments, the first seal is exposed to the heat transfer zone and the isolation zone; and the second seal is exposed to the isolation zone and an outlet zone of the reactor.

In some embodiments, an inlet zone of the reactor is defined, at least in part, by: a first end portion of the shell; and an upper surface of the tube sheet.

In some embodiments, the heat transfer zone is defined, at least in part, by: an intermediate portion of the shell; an upper surface of the first boundary; and a first portion of the first seal.

In some embodiments, an outlet zone of the reactor is defined, at least in part, by: a second end portion of the shell; a lower surface of the second boundary; and a second portion of the second seal.

In some embodiments, the reactor comprises: a sensor configured to enable the measurement of a sensor parameter associated with the isolation zone; and a controller that is configured to determine process data using a value of the sensor parameter measured using the sensor.

In some embodiments, the controller is configured to transmit a signal in response to a process data value meeting a process criterion.

In a second aspect there is disclosed a reactor comprising:
a shell enveloping: a plurality of tubes forming a reaction zone adapted for facilitating a reaction, and a heat transfer zone, each of the plurality of tubes provided with open opposite inlet and outlet ends;
the shell provided with: a feed fluid inlet in communication with the inlet ends of the tubes and a product fluid outlet in communication with the outlet ends of the tubes, and a fluid impervious wall fluidically isolating the inlet from the outlet and the inlet end from the outlet ends;
each tube having at least one bend between the inlet end and the outlet end; wherein a feed fluid fed into the feed fluid inlet flows through the tubes and is heated by a heat transfer fluid flowing through the heat transfer zone and reacts to form a product fluid that flows out of the shell through the product fluid outlet.

In some embodiments, there is provided a reactor. The reactor may comprise a shell enveloping: a plurality of tubes forming a reaction zone adapted for facilitating a reaction, and a heat transfer zone, each of the plurality of tubes provided with open opposite inlet and outlet ends. The shell may be provided with: a feed fluid inlet in communication with the inlet ends of the tubes, a product fluid outlet in communication with the outlet ends of the tubes, and a fluid impervious wall fluidically isolating, except through the tubes, the inlet from the outlet and the inlet ends from the outlet ends. The reactor may comprise a tube sheet extending within and across the shell. The reactor may comprise a wall extending within and across the shell, the wall being spaced apart from the tube sheet, the wall comprising a first wall opening and a second wall opening. The heat transfer zone may extend between the tube sheet and the wall. A tube of the plurality of tubes may extend from the heat transfer zone to an intermediate zone of the reactor on an opposing side of the wall from the heat transfer zone, through the first wall opening. The tube may extend from the intermediate zone to the heat transfer zone, through the second wall opening. The tube comprises at least one bend between the inlet end and the outlet end, in the intermediate zone, the at least one bend defining an intermediate reaction zone portion of the tube. A catalyst may be provided in the tube. The intermediate reaction zone portion may comprise a catalyst-free portion. The reactor may comprise a sealing system that is configured to form a fluid seal between the heat transfer zone and the intermediate zone. The reactor may be configured such that, in use, a feed fluid fed into the feed fluid inlet flows through the tubes and is heated by a heat transfer fluid flowing through the heat transfer zone and reacts to form a product fluid that flows out of the shell through the product fluid outlet.

In some embodiments, the reactor comprises a baffle located within the shell and forming a fluid impervious barrier between the inlet ends and the outlet ends of the tubes.

In some embodiments, the reactor comprises a tube sheet extending within and across the shell and a lower wall extending within and across the shell spaced from the tube sheet wherein the heating zone is confined between the tube sheet and the lower wall.

In some embodiments, one bend in each of the tubes is in a region between the lower wall and the interior of the shell.

In some embodiments, one or more bend in each of the tubes is on an opposing side of the lower wall to the tube sheet.

In some embodiments, the lower wall comprises a first wall opening that extends from a first side of the wall to a second side of the wall; and one of the plurality of tubes extends from the heat transfer zone to an intermediate zone of the reactor on an opposing side of the wall from the heat transfer zone, through the first wall opening.

In some embodiments, the lower wall comprises as second wall opening that extends from the first side of the wall to the second side of the wall; and the one of the plurality of tubes extends from the intermediate zone to the heat transfer zone, through the second wall opening.

In some embodiments, the reactor comprises a sealing system forming a substantial fluid seal between the heat transfer zone and the region.

In some embodiments, the reactor comprises a sealing system, the sealing system comprising, for each tube, a first seal and a second seal, the first seal forming a substantial seal about a first part of that tube adjacent the lower wall and the second seal forming a substantial seal about a second part of that tube adjacent the lower wall, wherein the first part and the second part of the tube are on opposite sides of a common bend of that tube.

In some embodiments, each first seal is connected to the lower wall, and contacts the first part of the respective tube; and each second seal is connected to the lower wall, and contacts the second part of the respective tube.

In some embodiments, the first seal is exposed to the heat transfer zone and the intermediate zone, and the second seal is exposed to the heat transfer zone and the intermediate zone.

In some embodiments, the reactor comprises a sensor configured to enable the measurement of a sensor parameter associated with the isolation zone; and a controller that is configured to determine process data using a value of the sensor parameter measured using the sensor.

In some embodiments, the controller is configured to transmit a signal in response to a process data value meeting a process criterion.

In some embodiments, a catalyst is provided in one or more of the tubes; and each tube that comprises the catalyst comprises a catalyst-free portion.

In some embodiments, the at least one bend of each tube within which the catalyst is provided defines at least part of the catalyst-free portion of that tube.

### BRIEF DESCRIPTION OF THE DRAWINGS

Notwithstanding any other forms which may fall within the scope of the Reactor as set forth in the Summary, specific embodiments will now be described, by way of example only, with reference to becoming drawings in which:

FIG. 1 is a schematic representation of a first embodiment of the disclosed heat exchange reactor; and

FIG. 2 is a schematic representation of a second embodiment of the disclosed heat exchange reactor.

### DETAILED DESCRIPTION

A feed fluid can be directed through a heat exchange reactor to facilitate a reaction associated with the feed fluid. For example, a heat exchange reactor can be used for the reforming of hydrocarbons to produce a product fluid. The feed fluid is fed through an inlet of the heat exchange reactor, and through a flow path within the heat exchange reactor. The heat exchange reactor is configured such that the feed fluid reacts as desired as it transits the flow path, thereby producing a product fluid.

Heat exchange reactors can operate at relatively high temperatures (for example, in excess of 350° C.) to assist with facilitating the desired reaction. The resultant product gas can also be of a relatively high temperature (for example, around 600° C. to 950° C. or higher). The process therefore involves the use of high temperature fluids that may be chemically dissimilar and dangerous to handle and/or when mixed. There can be significant thermal expansion of one or more components of the heat exchange reactor. The flow path through the heat exchange reactor may comprise one or more tubes through which the feed fluid is directed. The high operating temperature of the heat exchange reactor can cause significant thermal expansion of these tubes, which may need to be accounted for with components that come into physical contact with the tubes.

A heat transfer fluid can be used to facilitate the reaction within a heat exchange reactor. The heat transfer fluid is a fluid that is brought into thermal contact with the feed fluid to provide a reaction heat for one or more reactions or remove heat from one or more reactions, thereby assisting with enabling the desired reaction(s).

The heat transfer fluid may be presented at a heat transfer fluid inlet of the heat exchange reactor at a temperature of about 400° C. to 2000° C. For endothermic reactions, significant energy is used in heating the heat transfer fluid to an operating temperature within this range. Providing this energy from a renewable energy source can significantly reduce adverse environmental impacts of operating the heat exchange reactor. It is therefore desirable for a heat exchange reactor to be capable of handling a heat transfer fluid that is heated by a renewable energy source.

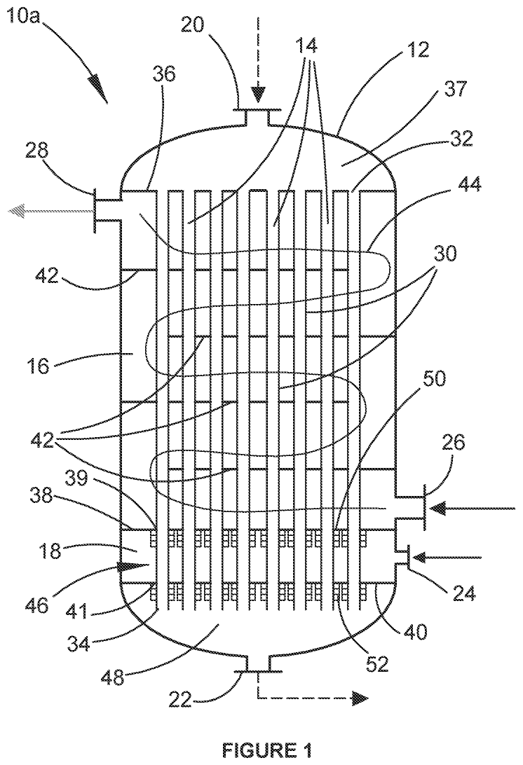

FIG. 1 illustrates one embodiment of a first aspect of the disclosed heat exchange reactor (hereinafter “reactor”) 10a. In some embodiments, the heat exchange reactor 10a may be referred to as a heat exchange reformer. Alternatively, the heat exchange reactor 10a may be referred to as a reformer. The reactor 10a comprises a shell 12 which envelopes a reaction zone 14, a heat transfer zone 16, and an isolation zone 18. The shell 12 also has: a feed fluid inlet 20, a product fluid outlet 22, an isolation fluid inlet 24, a heat transfer fluid inlet 26 and a heat transfer fluid outlet 28.

The reactor comprises a plurality of tubes 30. One or more of the plurality of tubes 30 may be referred to as a pipe. The plurality of pipes or tubes 30 extend vertically within the shell 12. Each tube 30 is open at its opposite ends 32 and 34. Feed gas flows through the reactor 10a from the feed fluid inlet 14 to the product fluid outlet 22 via the tubes 30. The end 32 of each tube 30 is an upstream end while the opposite end 34 is the downstream end with reference to this direction of flow of the feed gas. The collective interior volume of the tubes 30 make up the reaction zone 14. In other words, the tubes 30 define the reaction zone 14. Alternatively, the reaction zone 14 may be said to comprise at least a portion of the plurality of tubes (30) and/or a volume of at least a portion of the plurality of tubes (30).

The upstream ends 32 open onto a tube sheet 36 that extends across the inside of the shell 12. The tube sheet 36 is connected to the shell 12. In particular, the tube sheet 36 is removably connected to the shell 12. One or more of the tubes 30 are connected to the tube sheet 36 at their respective upstream end 32. One or more of the tubes 30 are permanently connected to the tube sheet 36. An inlet zone 37 inside the shell 12 from the inlet 20 to the tube sheet 36 acts like a manifold feeding the feed gas into the inlet end 32 of each tube 30. The tubes 30 also extend through a first boundary or wall 38, and a second boundary or wall 40 which are successively downstream of the tube sheet 36. The downstream end 34 of each tube 30 extends past the second wall 40. The first wall 38 is connected to the shell 12. The first wall 38 extends across the inside of the shell 12. The second wall 40 is connected to the shell 12. The second wall extends across the inside of the shell 12. The tube sheet 36 is between the feed fluid inlet 20 and the first wall 38. The first wall 38 defines a plurality of first wall openings 39. Each first wall opening 39 extends from a first side of the first wall 38 to a second side of the first wall 38. Each first wall opening 39 is configured to enable a corresponding tube 30 to extend through the first wall 38. The second wall 40 comprises a plurality of second wall openings 41. Each second wall opening 41 extends from a first side of the second wall 40 to a second side of the second wall 40. Each second wall opening 41 is configured to enable a corresponding tube 30 to extend through the second wall 40.

A plurality of baffles 42 extend horizontally within the shell 12. The baffles 42 are vertically spaced apart and alternately extend from opposite sides of the shell 12. The baffles 42 and shell 12 together form a serpentine flow path 44 for a heat transfer fluid flowing through the shell 12 from the inlet 26 to the outlet 28. The heat transfer fluid is provided at a pressure Pheat. The heat transfer fluid may be referred to as a heat transfer medium. The heat transfer fluid may be referred to as a heat exchange medium. The heat transfer fluid may be referred to as a heat exchange fluid. The tubes 30 extend through the baffles 42.

The region within the shell 12 between the tube sheet 36, the first wall 38 and exterior of the tubes 30 forms the heat transfer zone 16. The interior volume of the tubes 30 forms the reaction zone 14. The region between the first and second walls 38 and 40 forms the isolation zone 18.

The reactor 10a also includes a sealing system 46. The sealing system 46 forms a substantial fluid seal between the heat transfer zone 16 and the product fluid outlet 22. A function of the sealing system 46 is to prevent or at least substantially retard the mixing of the heat exchange fluid with the product gas formed by the flow of the feed gas through the reaction zone 14 while accommodating expansion of the tubes 30. The product gas flows from the tube ends 34 into an outlet zone 48 formed in the shell 12 between the second wall 40 and the outlet 22. The outlet zone 48 may be referred to as a product zone.

The sealing system 46 in this, but not necessarily all embodiments comprises, for each tube 30, a first seal 50 and a second seal 52. The first seal 50 may be referred to as an upper seal. The first seal 50 may be referred to as an upstream seal. The second seal 52 may be referred to as a lower seal 52. The second seal 52 may be referred to as a downstream seal. The first seal 50 forms a substantial seal about a first part of an associated tube 30 adjacent the first wall or boundary 38 between the isolation zone 18 and the heat transfer zone 16. The first seal 50 is configured to contact the first part of the associated tube 30. The first seal 50 may support the first part of the associated tube 30, to inhibit movement of the tube 30 in a direction that is transverse to the longitudinal direction of the tube 30. The first seal 50 is connected to the first wall 38. In some embodiments, the first seal 50 is connected to the first wall 38 at a first wall opening 39 of the first wall 38. The first seal 50 may traverse a perimeter of the first wall opening 39. The second seal 52 forms a substantial seal about a different part of that tube 30 adjacent the second wall or boundary 40 between the isolation zone 18 and the outlet zone 48 and consequently the product fluid outlet 22. The second seal 52 is configured to contact the second part of the associated tube 30. The second seal 52 may support the second part of the associated tube 30, to inhibit movement of the tube 30 in a direction that is transverse to the longitudinal direction of the tube 30. The second seal 52 is connected to the second wall 40. In some embodiments, the second seal 52 is connected to the second wall 40 at a second wall opening 41 of the second wall 40. The second seal 52 may traverse a perimeter of the second wall opening 41. By virtue of the first and second seals 50, 52 for each tube 30, the sealing system 46 may be considered to be a dual seal system.

The seals 50, 52 used in the sealing system 46 may take various forms including, but not limited to, those described in the published patent specifications WO2015132555 or EP0843590B1.

The inlet zone 37 is defined, at least in part, by a number of parts of the reactor 10a. A portion of the shell 12 defines at least part of the inlet zone 37. In other words, the portion of the shell 12 forms a first part of an external boundary of the inlet zone 37. Specifically, an inner surface of the shell 12 forms the first part of the external boundary of the inlet zone 37. The portion of the shell 12 that defines at least part of the inlet zone 37 may be referred to as a first end portion of the shell 12. A portion of the tube sheet 36 defines at least part of the inlet zone 37. In other words, the portion of the tube sheet 36 forms a second part of the external boundary of the inlet zone 37. Specifically, an upper surface of the tube sheet 36 forms the second part of the external boundary of the inlet zone 37. In some embodiments, a portion of one or more of the tubes 30 defines at least part of the inlet zone 37. In other words, the portion of one or more of the tubes 30 forms a third part of the external boundary of the inlet zone 37. The portion of one or more of the tubes 30 may be a top portion of the tubes 30 (for example, a top surface of the tubes 30).

The heat transfer zone 16 is defined, at least in part, by a number of parts of the reactor 10a. A portion of the shell 12 defines at least part of the heat transfer zone 16. In other words, the portion of the shell 12 forms a first part of an external boundary of the heat transfer zone 16. Specifically, an inner surface of the shell 12 forms the first part of the external boundary of the heat transfer zone 16. The portion of the shell 12 that defines at least part of the heat transfer zone 16 may be referred to as an intermediate portion of the shell 12. A portion of the tube sheet 36 defines at least part of the heat transfer zone 16. In other words, the portion of the tube sheet 36 forms a second part of the external boundary of the heat transfer zone 16. Specifically, a lower surface of the tube sheet 36 forms the second part of the external boundary of the heat transfer zone 16. A portion of the first wall 38 defines at least part of the heat transfer zone 16. In other words, the portion of the first wall 38 forms a third part of an external boundary of the heat transfer zone 16. Specifically, an upper surface of the first wall 38 forms the third part of the external boundary of the heat transfer zone 16. A portion of one or more of the first seals 50 defines at least part of the heat transfer zone 16. In other words, the portion of one or more of the first seals 50 forms a fourth part of the external boundary of the heat transfer zone 16. Thus, a portion of one or more of the first seals 50 is exposed to the heat transfer zone 16. Heat transfer zone 16 may be said to be defined by a heating chamber of the reactor 10a.

The isolation zone 18 is defined, at least in part, by a number of parts of the reactor 10a. A portion of the shell 12 defines at least part of the isolation zone 18. In other words, the portion of the shell 12 forms a first part of an external boundary of the isolation zone 18. Specifically, the inner surface of the shell 12 forms the first part of the external boundary of the isolation zone 18. The portion of the shell 12 that defines at least part of the isolation zone 18 may be referred to as an intermediate portion of the shell 12. A portion of the first wall 38 defines at least part of the isolation zone 18. In other words, the portion of the first wall 38 forms a second part of the external boundary of the isolation zone 18. Specifically, a lower surface of the first wall 38 forms the second part of the external boundary of the isolation zone 18. A portion of the second wall 40 defines at least part of the isolation zone 18. In other words, the portion of the second wall 40 forms a third part of an external boundary of the isolation zone 18. Specifically, an upper surface of the second wall 40 forms the third part of the external boundary of the isolation zone 18. A portion of one or more of the first seals 50 defines at least part of the isolation zone 18. In other words, the portion of one or more of the first seals 50 forms a fourth part of the external boundary of the isolation zone 18. Thus, a portion of one or more of the first seals 50 is exposed to the isolation zone 18. A portion of one or more of the second seals 52 defines at least part of the isolation zone 18. In other words, the portion of one or more of the second seals 52 forms a fifth part of the external boundary of the isolation zone 18. Thus, a portion of one or more of the second seals 52 is exposed to the isolation zone 18.

The outlet zone 48 is defined, at least in part, by a number of parts of the reactor 10a. A portion of the shell 12 defines at least part of the outlet zone 48. In other words, the portion of the shell 12 forms a first part of an external boundary of the outlet zone 48. Specifically, the inner surface of the shell 12 forms the first part of the external boundary of the outlet zone 48. The portion of the shell 12 that defines at least part of the outlet zone 48 may be referred to as a second end portion of the shell 12. A portion of the second wall 40 defines at least part of the outlet zone 48. In other words, the portion of the second wall 40 forms a second part of the external boundary of the outlet zone 48. Specifically, a lower surface of the second wall 40 forms the second part of the external boundary of the outlet zone 48. A portion of one or more of the second seals 52 defines at least part of the outlet zone 48. In other words, the portion of one or more of the second seals 52 forms a third part of the external boundary of the outlet zone 48. Thus, a portion of one or more of the second seals 52 is exposed to the outlet zone 48.

The isolation zone 18 is in fluid communication with a supply of a purge gas via the inlet 24. The purge gas is supplied at a pressure greater than the pressure of the heat transfer fluid in the heat transfer zone 16.

As described herein, there can be significant thermal expansion of one or more components of the reactor 10a during the start-up and operation of the reactor 10a, at least in part as a result of the difference in temperature between ambient conditions and the operating temperature of the reactor 10a. The plurality of tubes 30 extend vertically within the shell 12 and are connected to the tube sheet 36 at their respective upstream ends 32. The downstream ends 34 of the plurality of tubes 30 are free. That is, the downstream ends 34 of the plurality of tubes 30 may be referred to as free ends of the tubes 30.

The general idea of the sealing system 46 is to allow expansion and contraction of the tubes 30 within the shell 12 while maintaining a substantial fluid seal between the reaction zone 14 and the outlet 22 and outlet zone 18. In other words, the sealing system 46 enables expansion and contraction of the tubes 30 within the shell 12 while inhibiting the transfer of fluid between the heat transfer zone 16 and the isolation zone 18. Similarly, the sealing system 46 enables expansion and contraction of the tubes 30 within the shell 12 while inhibiting the transfer of fluid between the isolation zone 18 and the outlet zone 48. This is to prevent, or at least inhibit, contamination of the product gas with the heat transfer fluid. Further, the sealing system 46 also prevents, or at least inhibits contamination of the heat transfer fluid with product gas.

The first seals 50 are configured to enable their respective tubes 30 to expand and contract while inhibiting the transfer of fluid between the between the heat transfer zone 16 and the isolation zone 18. In particular, the first seals 50 are configured to inhibit the transfer of heat transfer fluid from the heat transfer zone 16 to the isolation zone 18.

The first seals 50 enable a change in an outer dimension of the tubes 30 while inhibiting the transfer of fluid between the between the heat transfer zone 16 and the isolation zone 18. In some embodiments, the first seals 50 are configured to enable an increase in a diameter of the tubes 30 passing through the first wall 38. That is, the first seals 50 are configured to inhibit the transfer of fluid between the heat transfer zone 16 and the isolation zone 18 with an increase in the diameter of the tubes 30. Further, the first seals 50 are configured to enable a decrease in the diameter of the tubes 30 passing through the first wall 38. That is, the first seals 50 are configured to inhibit the transfer of fluid between the heat transfer zone 16 and the isolation zone 18 with a decrease in the diameter of the tubes 30. The first seals 50 may therefore comprise a resilient material.

The first seals 50 enable a change in a longitudinal dimension of the tubes 30 while inhibiting the transfer of fluid between the heat transfer zone 16 and the isolation zone 18. Specifically, the first seals 50 assist in inhibiting the transfer of heat transfer fluid into the isolation zone 18. In other words, the first seals 50 enable a change in a length of the tubes 30 while inhibiting the transfer of fluid between the heat transfer zone 16 and the isolation zone 18. The first seals 50 inhibit the transfer of fluid between the heat transfer zone 16 and the isolation zone 18 throughout an increase in the longitudinal dimension of the tubes 30. In other words, the first seals 50 inhibit the transfer of fluid between the heat transfer zone 16 and the isolation zone 18 as the tubes 30 expand downward, away from the tube sheet 36. The first seals 50 also inhibit the transfer of fluid between the heat transfer zone 16 and the isolation zone 18 throughout a decrease in the longitudinal dimension of the tubes 30. In other words, the first seals 50 inhibit the transfer of fluid between the heat transfer zone 16 and the isolation zone 18 as the tubes 30 contract upward, towards the tube sheet 36. As the longitudinal dimension of the tubes 30 changes, the tubes 30 slide through their respective first seals 50. The first seals 50 may therefore be referred to as sliding seals.

The second seals 52 are configured to enable their respective tubes 30 to expand and contract while inhibiting the transfer of fluid between the between the outlet zone 48 and the isolation zone 18. In particular, the second seals 52 are configured to inhibit the transfer of product gas from the outlet zone 48 to the isolation zone 18. Together, the first seals 52 and the second seals 52 are configured to inhibit the transfer of heat transfer fluid from the heat transfer zone 16 to the outlet zone 48. Similarly, the first seals 50 and the second seals 52 are configured to inhibit the transfer of product gas from the outlet zone 48 to the heat transfer zone 16.

The second seals 52 enable a change in an outer dimension of the tubes 30 while inhibiting the transfer of fluid between the outlet zone 48 and the isolation zone 18. In some embodiments, the second seals 52 are configured to enable an increase in a diameter of the tubes 30 passing through the second wall 40. That is, the second seals 52 are configured to inhibit the transfer of fluid between the outlet zone 48 and the isolation zone 18 with an increase in the diameter of the tubes 30. Further, the second seals 52 are configured to enable a decrease in the diameter of the tubes 30 passing through the second wall 40. That is, the second seals 52 are configured to inhibit the transfer of fluid between the outlet zone 48 and the isolation zone 18 with a decrease in the diameter of the tubes 30. The second seals 52 may therefore comprise a resilient material.

The second seals 52 enable a change in a longitudinal dimension of the tubes 30 while inhibiting the transfer of fluid between the outlet zone 48 and the isolation zone 18. In other words, the second seals 52 enable a change in a length of the tubes 30 while inhibiting the transfer of fluid between the outlet zone 48 and the isolation zone 18. The second seals 52 inhibit the transfer of fluid between the outlet zone 48 and the isolation zone 18 throughout an increase in the longitudinal dimension of the tubes 30. In other words, the second seals 52 inhibit the transfer of fluid between the outlet zone 48 and the isolation zone 18 as the tubes 30 expand downward, away from the tube sheet 36. The second seals 52 also inhibit the transfer of fluid between the outlet zone 48 and the isolation zone 18 throughout a decrease in the longitudinal dimension of the tubes 30. In other words, the second seals 52 inhibit the transfer of fluid between the outlet zone 48 and the isolation zone 18 as the tubes 30 contract upward, towards the tube sheet 36. As the longitudinal dimension of the tubes 30 changes, the tubes 30 slide through their respective second seals 52. The second seals 52 may therefore be referred to as sliding seals.

Because of the sealing system 46, in order for the heat transfer fluid to reach the product gas in the outlet zone 48 it must pass through the upper seal 50 and the lower seal 52. Similarly, in order for the product gas to reach the heat transfer zone 16, it must pass through the lower seal 52 and the upper seal 50. The prevention of contamination is further enhanced by the provision of the purge gas in the isolation zone 18 at a positive pressure relative to that of the heat exchange fluid.

The relative pressure relationship between the purge gas in the isolation zone 18 and the product gas in the product outlet zone 48 may vary in different operating conditions of the reactor 10a. In some embodiments the pressure of the purge gas in the isolation zone 18 may be the same or slightly less than that of the product gas in the product outlet zone 48. This relative pressure relationship may be applicable in a scenario where it does not matter if some of the product gas leaks back into the purge gas supply. However, in other embodiments, the pressure of the purge gas in the isolation zone may be higher than that of the product gas in the outlet zone 48. The management of the pressure differential between the purge gas in the isolation zone 18 and the product gas in the outlet zone 48 is dependent on several factors including, but not limited to, the leak rate of the seals, the product value of the product gas, and the purification required of the product gas and the purge gas.

In one example the reactor 10a may be used for the bi-reforming of natural gas with carbon dioxide and steam/water. This combination of fluids constitutes the feed fluid which flows in through the inlet 20. This feed gas may be presented at a temperature greater than 500° C. and a pressure of between 10-30 bar. The heat transfer fluid may be in the form of superheated steam at a temperature range of about 400° C. to 2000° C. such as for example between 1000-1200° C. and presented at a pressure Pheat of between 3-22 bar at the heat transfer fluid inlet 26. The heat transfer fluid follows the serpentine path 44 leaving the shell 12 at the outlet 28 at a lower temperature for example in the order of 800°−900° C. and at a lower pressure of between 1-20 bar.

The purge fluid which may ideally be in the form of an inert gas is presented to the purge fluid inlet 24 at a pressure Ppurge=Pheat+Δ where Δ>0 such as for example 1<Δ<8 bar. For example, when the heat transfer fluid is at a pressure of between 3-22 bar then the purge gas may be at a pressure of between 8-28 bar.

The product gas in the product zone 48 and leaving the outlet 22 may have a temperature in the range of 350° C.-950° C. and a pressure Pproduct of between 2-30 bar. As previously mentioned, different embodiments or methods of working the reactor 10a envisage either one of the following pressure relationships:
Ppurge=Pproduct
Ppurge<Pproduct
Ppurge=Pproduct+Δ where Δ>0 such as for example 1<Δ<8 bar

When the reactor 10a is used for the bi-reforming process, a catalyst (not shown) is provided within the reaction zone 14/tubes 30. The catalyst may be a nickel base catalyst.

The main reactions occurring within the reaction zone 14/tubes 30 are set out below.

CO₂+CH₄=CO+2H₂

CH₄+H₂O=3H₂+CO

CO₂+H₂=CO+H₂O

In some embodiments, these reactions may be expressed as below:

CO₂+CH₄↔CO+2H₂

CH₄+H₂O ↔3H₂+CO

CO₂+H₂↔CO+H₂O

The operating conditions of the reactor 10a, when used in the bi-reforming of natural gas, result in the sealing system 46 operating under thermally extreme conditions. The heat transfer fluid and the product gas and feed gas are dissimilar. As described herein, the feed gas may be presented at a temperature greater than 500° C. The heat transfer fluid may be in the form of superheated steam at a temperature range of about 400° C. to 2000° C. Further, one or more of the main reactions occurring within the reaction zone 14 are endothermic. There is therefore a significant temperature difference between the heat transfer fluid and the feed gas within the reaction zone 14. There is also a significant temperature difference between the heat transfer fluid and the isolation zone 18. Further, the fluid in the reaction zone 14 may be presented at a significantly higher pressure than the fluid in the heat transfer zone 16. Similarly, the product gas in the outlet zone 48 may be presented at a significantly higher pressure than the fluid in the heat transfer zone 16. The dual seal system described herein provides significant technical advantages under these, and other operating conditions.

If a heat exchange reactor were to include only a sliding seal at a boundary between a heat transfer zone for a heat transfer fluid and an outlet zone for a product gas (i.e. not include the isolation zone 18 described herein), a small amount of fluid may leak from the high-pressure side of the boundary to the low pressure side of the boundary. If the outlet zone of such a reactor were to be at a higher pressure than the heat transfer zone, a small amount of product gas may continuously flow to the heat transfer zone, contaminating the heat transfer fluid. An accumulation of product gas (e.g. synthesis gas which may contain CO and H₂) in heat transfer fluid may therefore occur in such a reactor. In addition to contamination of the heat transfer fluid, the product gas may be flammable and its accumulation in heat transfer fluid may increase the risk of adverse safety outcomes. This mixing may therefore necessitate the constant removal of product gas from the heat transfer fluid of such a reactor.

The physical configuration of the reactor 10a described herein, including the isolation zone 18 and the sealing system 46, provides a solution to these technical problems. The reactor 10a of the present application includes the isolation zone 18 as a buffer in a case where there is leakage of product gas through the second seals 52. In this case, the first seals 50 inhibit the transfer of the product gas to the heat transfer zone 16. Similarly, the provision of purge gas at the appropriate pressure can inhibit the transfer of the product gas into the isolation zone 18 and/or the heat transfer zone 16.

The isolation zone 18 is also a buffer in the case that heat transfer fluid leaks through the first seals 50. In this case, the second seals 52 inhibit the transfer of the heat transfer fluid to the output zone 48. Similarly, the provision of purge gas at the appropriate pressure can inhibit the transfer of the heat transfer fluid into the isolation zone 18 and/or the outlet zone 48.

The reactor 10a described herein therefore provides improved separation between the heat transfer fluid and the product gas. The reactor also enables the use of a heat transfer medium that is dissimilar to the product gas (i.e. the use of a heat transfer fluid that may be referred to as an incompatible fluid, such as air).

In some embodiments, the reactor 10a comprises one or more sensors (not shown). The one or more sensors are associated with the isolation zone 18. The one or more sensors may be provided within the isolation zone 18. The one or more sensors 18 enable the measurement of one or more parameters associated with the isolation zone 18. The one or more sensors may comprise one or more of a temperature sensor, a pressure sensor, a gas detector and a vibration sensor. The reactor 10a comprises a controller (not shown). The controller may be electrically connected to the one or more sensors. Alternatively, the controller may be in communication with the one or more sensors remotely (e.g. via a wireless data transmission network). The controller is configured to determine process data using a value of a sensor parameter associated with the isolation zone 18. In other words, the controller is configured to determine a value of the process data. For example, where the one or more sensors comprise a temperature sensor, temperature can be the sensor parameter and the value may be a voltage associated with the temperature sensor (e.g. in the case of a thermocouple). The process data in this case may be a process data value that is indicative the temperature of the environment adjacent the temperature sensor.

The controller can detect a failure of a first seal 50 and/or a failure of a second seal 52 based on the sensor data. For example, an increase in the temperature of the isolation zone 18 above a temperature threshold may indicate that a first seal 50 has failed, resulting in a leak of heat transfer fluid into the isolation zone. The controller can transmit a signal to one or more pieces of process equipment in response to determining that a failure of a first seal 50 and/or a second seal 52 has occurred. In other words, the controller is configured to transmit the signal in response to determining that a process data value meeting a process criterion. In this case, the process criterion is the temperature of the isolation zone 18 being above a temperature threshold. The signal may be a process shutdown signal configured to start an automatic shutdown of the reactor 10a.

In some embodiments, the reactor 10a comprises an isolation zone outlet (not shown). In some embodiments, rather than housing static purge gas, purge gas may be fed through the isolation zone and out of the isolation zone outlet at a purge gas flow rate. In some embodiments, the isolation zone outlet is a drain. The drain may be configured to enable product gas and/or heat transfer fluid that has leaked into the isolation zone 18 to be drained from the isolation zone 18. The drain may therefore be considered an isolation zone fluid outlet.

The reactor 10a may be used in various reforming or other processing plant designs, including those described in Applicant's co-pending Australian provisional patent application numbers 2020901146 and 2020903596 the contents of which are incorporated herein by way of reference. These provisional patent applications described a renewable energy hydrocarbon processing method and plant in which the thermal energy required to drive the bi-reforming process (i.e. for heating the heat transfer fluid) is sourced from renewable energy sources and may include, but is not limited to, one, or a combination of two or more of the following energy conversion processes/systems:
concentrated solar thermal plant
photovoltaic cells
wind turbine generator
geothermal heat source
ocean wave energy conversion apparatus

The reactor 10a described herein therefore enables the consumption carbon dioxide in the production of product gas comprising synthesis gas. In other words, the reactor 10a described herein enables the consumption of a gas attributed to significant adverse environmental outcomes in increasing atmospheric concentrations to a product gas that is, or can be processed into a valuable commodity. This reaction can be supported by a heat transfer fluid that is heated using a renewable energy source. This combination of features can significantly reduce the net effective emissions that result from the bi-reforming of natural gas using the reactor 10a. The product gas may therefore be considered a low emission reformed product.

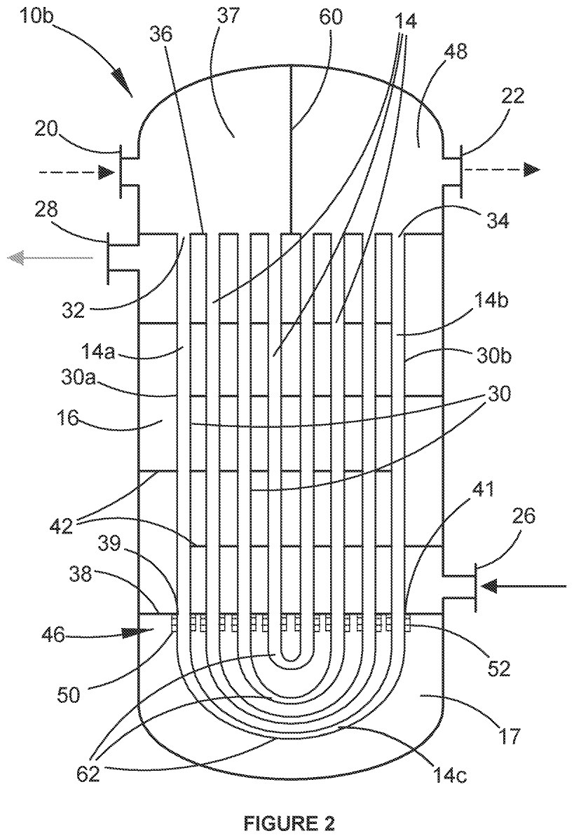

FIG. 2 illustrates another aspect of the disclosed heat exchange reactor, designated as 10b. In describing this embodiment, the same reference numbers will be used as for the first embodiment of the reactor 10a shown in FIG. 1 to denote the same or functionally similar features.

The substantive differences between the reactors 10a and 10b are the:
reconfiguration of the heat transfer zone 16 and the reaction zone 14;
provision of a bend in the tubes 30 so that in effect there are fewer tubes 30 in the reactor 10b but that these tubes are about twice as long as those in the reactor 10a; and
omission of the isolation zone 18.

The reactor 10b comprising a shell 12 enveloping: a plurality of tubes 30 forming a reaction zone 14 adapted for facilitating a reforming or other reaction; and, a heat transfer zone 16. The shell 12 also envelopes an intermediate zone 17. The intermediate zone 17 may be referred to as a non-catalytic zone. Each of the plurality of tubes 30 has an open inlet end 32 and outlet end 34. The shell 12 has: a feed fluid inlet 20 in communication with the inlet ends 32 of the tubes 30 and a product fluid outlet 22 in communication with the outlet ends 34 of the tubes 30. A fluid impervious wall or baffle 60 fluidically isolates the inlet 20 from the outlet 22 and the inlet ends 32 from the outlet ends 34.

Each tube 30 has at least one (in this embodiment, only one) bend between its inlet end 32 and the outlet end 34. When a feed fluid flows from the feed fluid inlet 20, through the reaction zone 14/tubes 30 it is heated by a heat transfer fluid flowing through the heat transfer zone 16 and reacts to form a product fluid/syngas that flows out of the shell 12 through the product fluid outlet 22. The at least one bend is provided in the intermediate zone 17.

The reactor 10b has a plurality of baffles 42 in the heat transfer zone 16 to create a serpentine flow path for the heat transfer fluid, a tube sheet 36, a wall or boundary 38 through which the tubes 30 pass, and a sealing system 46. The tube sheet 36 is connected to the shell 12. One or more of the tubes 30 are connected to the tube sheet 36 at the respective upstream end 32. The connection may be a permanent connection (e.g. a welded connection). One or more of the tubes 30 are connected to the tube sheet 36 at the respective downstream end 34. The connection may be a permanent connection (e.g. a welded connection).

The wall 38 is connected to the shell 12. The wall 38 extends across the inside of the shell 12. The tube sheet 36 is between the feed fluid inlet 20 and the wall 38. The tube sheet 36 is between the feed fluid outlet 22 and the wall 38. The wall 38 defines a plurality of wall openings 39. Each wall opening 39 extends from a first side of the wall 38 to a second side of the wall 38. Each wall opening 39 is configured to enable a corresponding tube 30 to extend through the wall 38.

Each tube 30 comprises a first straight tube portion 30a. The first straight tube portion 30a defines the open inlet end 32. Each tube comprises a second straight tube portion 30b. The second straight tube portion defines the open outlet end 34. Each tube 30 is formed with a U-bend 62. The U-bend 62 is disposed in a region of the shell 12 below the wall 38. That is, the U-bend 62 is disposed in the intermediate zone 17. In other words, the wall 38 is between the U-bend 62 and the feed fluid inlet 20/product fluid outlet 22. The heat transfer zone 16 is bound between the walls 36, 38, and the inside of the shell 12. The reaction zone 14 is again constituted by the interior of the tubes 30.

In some embodiments, the reaction zone 14 comprises a first reaction zone portion 14a and a second reaction zone portion 14b. The first reaction zone portion 14a may be referred to as an upstream reaction zone portion. The second reaction zone portion 14b may be referred to as a downstream reaction zone portion. The first straight tube portion 30a may define some or all of the first reaction zone portion 14a. The second straight tube portion 30b may define some of all of the second reaction zone portion 14b. The first reaction zone portion 14a and the second reaction zone portion 14b are separated by an intermediate reaction zone portion 14c. The U-bends 62 of the tubes 30 define some or all of the intermediate reaction zone portion 14c of the respective tube 30.

A catalyst (not shown) is provided within at least part of the reaction zone 14 and/or tubes 30. In some embodiments, the catalyst is provided within the first straight tube portion 30a and the second straight tube portion 30b. In other words, the catalyst is provided within the first reaction zone portion 14a and the second reaction zone portion 14b. It is relatively more difficult to provide the catalyst within the U-bends 62. Therefore, in some embodiments, no catalyst is provided within the U-bends 62. In other words, the U-bends 62 may be considered catalyst-free. That is, the intermediate reaction zone portion 14c may be considered a catalyst-free zone. The intermediate reaction zone portion 14c may be referred to as a catalyst-free portion.

The sealing system 46 comprises, for each tube 30, a first seal 50 and a second seal 52. The first seal 50 may be referred to as an upper seal. The first seal 50 may be referred to as an upstream seal. The second seal 52 may be referred to as a lower seal 52. The second seal 52 may be referred to as a downstream seal. The seals 50 and 52 in this embodiment are located on opposite ends of the U-bend 62 for each tube 30 on a side of the wall 38 outside of the heating zone 16.

The first seal 50 forms a substantial seal about a first part of an associated tube 30 adjacent the wall 38. The first seal 50 is configured to contact the first part of the associated tube 30. The first seal 50 may support the first part of the associated tube 30, to inhibit movement of the tube 30 in a direction that is transverse to the longitudinal direction of the tube 30. The first seal 50 is connected to the wall 38. In some embodiments, the first seal 50 is connected to the wall 38 at a wall opening 39 of the wall 38. The first seal 50 may traverse a perimeter of the wall opening 39. The second seal 52 forms a substantial seal about a different (second) part of that tube 30, adjacent the wall 38. The second seal 52 is configured to contact the second part of the associated tube 30. The second seal 52 may support the second part of the associated tube 30, to inhibit movement of the tube 30 in a direction that is transverse to the longitudinal direction of the tube 30. The second seal 52 is connected to the wall 38. In some embodiments, the second seal 52 is connected to the wall 38 at a second wall opening 41 of the wall 38. The second seal 52 may traverse a perimeter of the second wall opening 41. By virtue of the first and second seals 50, 52 for each tube 30, the sealing system 46 may be considered to be a dual seal system.

The inlet zone 37 is defined, at least in part, by a number of parts of the reactor 10b. A portion of the shell 12 defines at least part of the inlet zone 37. In other words, the portion of the shell 12 forms a first part of an external boundary of the inlet zone 37. Specifically, an inner surface of the shell 12 forms the first part of the external boundary of the inlet zone 37. The portion of the shell 12 that defines at least part of the inlet zone 37 may be referred to as a first end portion of the shell 12. A portion of the tube sheet 36 defines at least part of the inlet zone 37. In other words, the portion of the tube sheet 36 forms a second part of the external boundary of the inlet zone 37. Specifically, an upper surface of the tube sheet 36 forms the second part of the external boundary of the inlet zone 37. In some embodiments, a portion of one or more of the tubes 30 defines at least part of the inlet zone 37. In other words, the portion of one or more of the tubes 30 forms a third part of the external boundary of the inlet zone 37. The portion of one or more of the tubes 30 may be a top portion of the tubes 30 (for example, a top surface of the tubes 30). A portion of the baffle 60 defines at least part of the inlet zone 37. In other words, the portion of the baffle 60 forms a fourth part of the external boundary of the inlet zone 37. Specifically, a first lateral surface of the baffle 60 forms the fourth part of the external boundary of the inlet zone 37.

The heat transfer zone 16 is defined, at least in part, by a number of parts of the reactor 10b. A portion of the shell 12 defines at least part of the heat transfer zone 16. In other words, the portion of the shell 12 forms a first part of an external boundary of the heat transfer zone 16. Specifically, an inner surface of the shell 12 forms the first part of the external boundary of the heat transfer zone 16. The portion of the shell 12 that defines at least part of the heat transfer zone 16 may be referred to as an intermediate portion of the shell 12. A portion of the tube sheet 36 defines at least part of the heat transfer zone 16. In other words, the portion of the tube sheet 36 forms a second part of the external boundary of the heat transfer zone 16. Specifically, a lower surface of the tube sheet 36 forms the second part of the external boundary of the heat transfer zone 16. A portion of the wall 38 defines at least part of the heat transfer zone 16. In other words, the portion of the wall 38 forms a third part of an external boundary of the heat transfer zone 16. Specifically, an upper surface of the wall 38 forms the third part of the external boundary of the heat transfer zone 16. A portion of one or more of the first seals 50 defines at least part of the heat transfer zone 16. In other words, the portion of one or more of the first seals 50 forms a fourth part of the external boundary of the heat transfer zone 16. Thus, a portion of one or more of the first seals 50 is exposed to the heat transfer zone 16. A portion of one or more of the second seals 52 defines at least part of the heat transfer zone 16. In other words, the portion of one or more of the second seals 52 forms a fourth part of the external boundary of the heat transfer zone 16. Thus, a portion of one or more of the second seals 52 is exposed to the heat transfer zone 16. Heat transfer zone 16 may be said to be defined by a heating chamber of the reactor 10a.

The intermediate zone 17 is defined, at least in part, by a number of parts of the reactor 10b. A portion of the shell 12 defines at least part of the intermediate zone 17. In other words, the portion of the shell 12 forms a first part of an external boundary of the intermediate zone 17. Specifically, an inner surface of the shell 12 forms the first part of the external boundary of the intermediate zone 17. The portion of the shell 12 that defines at least part of the inlet zone 37 may be referred to as a second end portion of the shell 12. A portion of the wall 38 defines at least part of the intermediate zone 17. In other words, the portion of the wall 38 forms a second part of the external boundary of the intermediate zone 17. Specifically, a lower surface of the wall 38 forms the second part of the external boundary of the intermediate zone 17.

The outlet zone 48 is defined, at least in part, by a number of parts of the reactor 10b. A portion of the shell 12 defines at least part of the outlet zone 48. In other words, the portion of the shell 12 forms a first part of an external boundary of the outlet zone 48. Specifically, the inner surface of the shell 12 forms the first part of the external boundary of the outlet zone 48. The portion of the shell 12 that defines at least part of the outlet zone 48 may be part of the first end portion of the shell 12. A portion of the tube sheet 36 defines at least part of the outlet zone 48. In other words, the portion of the tube sheet 36 forms a second part of the external boundary of the outlet zone 48. Specifically, an upper surface of the tube sheet 36 forms the second part of the external boundary of the outlet zone 48. A portion of the baffle 60 defines at least part of the outlet zone 48. In other words, the portion of the baffle 60 forms a third part of the external boundary of the outlet zone 48. Specifically, a second lateral surface of the baffle 60 forms the third part of the external boundary of the outlet zone 48.

When in use, a feed gas enters the reactor 10b through the inlet 20 and is distributed by the inlet zone 37 into the inlet ends 32 of each of the tubes 30. As the feed gas flows through the tubes 30 to the outlet end 34 it is heated by the heat transfer fluid which flows from the inlet 26 to the outlet 28 through the heating zone 16. The thermal energy imparted into the feed gas, together with any catalyst present within the tubes 30, facilitates the reactions described above in relation to the reactor 10a to produce a syngas.

In the absence of the catalyst, the reactions in the U-bends 62 of the tubes 30 are slowed. As there is no catalyst provided in the U-bends 62, it is beneficial to thermally isolate the U-bends 62 from the heat transfer medium. As described herein, one or more of the reactions are endothermic. The temperature of the feed gas within the reaction zone 14 and/or the tubes 30 will therefore decrease as the reactions occur, without an external heat source to elevate the fluid temperature and support the reactions. If the heat transfer fluid in contact with the U-bends 62 was the same temperature as that within the heat transfer zone 16, with the reduced rate of reaction within this region, the feed gas temperature may increase. This is because the endothermic reaction would not be extracting energy from the feed gas that would ordinarily be extracted if the endothermic reaction was occurring. If the temperature of the feed gas increases by too great of an extent, premature mechanical failure of the tubes 30 can occur. This can lead to adverse process safety outcomes or more different (more stringent) material requirements. In addition, in the absence of catalyst, significant cracking of methane may occur at high temperatures (e.g. 850-950° C.), leading to significant coke formation in the tubes 30. Increased coke formation may lead to blockage of the tubes 30.

The first seals 50 and the second seals 52 inhibit the transfer of fluid from the heat transfer zone 16 to the intermediate zone 17. The heat transfer fluid occupying the intermediate zone 17 is therefore likely of a lower temperature than that of the heat transfer fluid in the heat transfer zone 16. In other words, a temperature gradient is present between the heat transfer fluid in the heat transfer zone 16 and the heat transfer fluid in the intermediate zone 17. This reduces the likelihood of the temperature of the feed gas within the U-bends 62 increasing to undesirable levels. Additionally, the reduction of feed gas temperature at the U-bends 62 reduces the extent of coke formation as methane cracking is no thermodynamically favoured at a lower temperature. The arrangement of the reactor 10b provides a thermal management method for U-bends 62 which comprise catalyst-free zone 14c.

The arrangement of the reactor 10b also improves the energy efficiency of the reforming process. As described herein, significant amounts of energy are required to heat the heat transfer fluid, and maintain the heat transfer fluid at a target operating temperature. As there is no catalyst in the U-bends 62, the reforming reactions are inhibited within them. Therefore, heating the fluid adjacent the U-bends (i.e. the fluid within the intermediate zone 17) would require the consumption of energy without providing an appreciable impact on the efficiency of the reactor 10b. The sealing system 46 reduces or eliminates the transfer of fluid between the heat transfer zone 16 and the intermediate zone 17. As a result, the energy of the heat transfer fluid is more significantly retained within the heat transfer zone 16, for transfer to the fluid of the parts of the reaction zone 14 that comprise a catalyst. The sealing system 46 thereby improves the energy efficiency of the reactor 10b by reducing the amount of energy that would be wasted, if the heat transfer fluid of the intermediate zone 17 were maintained at the same or a similar temperature to that of the heat transfer zone 16. In other words, the sealing system 46 enables control of the temperature of the heat transfer fluid in the intermediate zone and/or the temperature of the U-bends 62/non-reaction zone to enhance the energy efficiency of the reactor 10b and/or the process plant.

The reactor 10b can be used in the same applications and plants as the reactor 10a.

Now that an embodiment has been described, it should be appreciated that the heat exchange reactors 10a, 10b maybe embodied in many other forms. For example, the tubes 30 may be provided with various catalysts to suit the process at hand. Also, the catalyst may be in different physical forms in different parts of the tubes 30. In relation to the embodiment shown in FIG. 10b the effective volume of the reaction zone 14 can be extended by extending the length of the tubes to include further U-bend sections so that the tubes 30 and the resultant free gas flow path travels along a serpentine route from the inlet 20 the outlet 22.

In the claims which follow, and in the preceding description, except where the context requires otherwise due to express language or necessary implication, the word “comprise” and variations such as “comprises” or “comprising” are used in an inclusive sense, i.e., to specify the presence of the stated features but not to preclude the presence or addition of further features in various embodiments of the system and method as disclosed herein.

What is claimed:

1. A reactor comprising:
a shell enveloping a reaction zone, a heat transfer zone, and an isolation zone;
the shell provided with a feed fluid inlet, a product fluid outlet, and an isolation fluid inlet, wherein the reaction zone provides fluid communication between the feed fluid inlet and the product fluid outlet, and extends though the heat transfer zone and the isolation zone, the isolation zone being located between the heat transfer zone and the product fluid outlet;
a tube sheet that is connected to the shell, and that extends across an inside of the shell;
a plurality of tubes that extend through the inside of the shell, each tube being connected to the tube sheet, and having an inlet opening in fluid communication with the feed fluid inlet and an outlet opening in fluid communication with the product fluid outlet;
a first wall that is connected to the shell and that extends across the inside of the shell, the first wall defining a plurality of first wall openings, each first wall opening being configured to enable a tube of the plurality of tubes to extend through the first wall;
a first seal that is connected to the first wall at one of the first wall openings, the first seal being configured to contact the tube that extends through the respective first wall opening, to form a seal about that tube, the first seal being configured to maintain the seal as a longitudinal dimension of the tube changes and the tube slides through the first seal;
a second wall that is connected to the shell and that extends across the inside of the shell, the second wall defining a plurality of second wall openings, each second wall opening being configured to enable a tube of the plurality of tubes to extend through the second wall; and
a second seal that is connected to the second wall at one of the second wall openings, the second seal being configured to contact the tube that extends through the respective second wall opening, to form a seal about that tube, the second seal being configured to maintain the seal as a longitudinal dimension of the tube changes and the tube slides through the second seal;
wherein:
each tube extends away from the tube sheet, through the first wall and the second wall, to a free end;
a collective interior volume of the tubes makes up the reaction zone; and
the reactor is configured such that, in use, a feed fluid, as it flows from the feed fluid inlet, through the reaction zone, is heated by a heat transfer fluid flowing through the heat transfer zone, and reacts to form a product fluid that flows out of the shell through the product fluid outlet, and a purge fluid in the isolation zone is at a positive pressure relative to a pressure of the heat transfer fluid flowing through the heat transfer zone and the product gas at the product fluid outlet.

2. The reactor according to claim 1, wherein the first seal is configured to seal with the tube that extends through the respective first wall opening to inhibit transfer of fluid between the heat transfer zone and the isolation zone.

3. The reactor according to claim 1, wherein the second seal is configured to seal with the tube that extends through the respective second wall opening to inhibit transfer of fluid between an outlet zone and the isolation zone.

4. The reactor according to claim 1, wherein a region between the first wall and the second wall defines the isolation zone.

5. The reactor according to claim 1, further comprising a catalyst disposed in the reaction zone.

6. The reactor according to claim 3, wherein the outlet zone is within the shell and in fluid communication between the reaction zone and the product fluid outlet, wherein in use, the product gas flows from the reaction zone into the outlet zone prior to flowing out of the product fluid outlet.

7. The reactor according to claim 1, wherein the first seal is exposed to the heat transfer zone and the isolation zone.

8. The reactor according to claim 3, wherein the second seal is exposed to the isolation zone and the outlet zone.

9. The reactor according to claim 1, wherein the inlet zone is defined, at least in part, by:
a first end portion of the shell; and
an upper surface of the tube sheet.

10. The reactor according to claim 1, wherein the heat transfer zone is defined, at least in part, by:
an intermediate portion of the shell;
a lower surface of the tube sheet;
an upper surface of the first wall; and
a first portion of the first seal.

11. The reactor according to claim 1, wherein the isolation zone is defined, at least in part, by:
a second intermediate portion of the shell;
a lower surface of the first wall;
a second portion of the first seal;
an upper surface of the second wall; and
a first portion of the second seal.

12. The reactor according to claim 3, wherein the outlet zone is defined, at least in part, by:
a second end portion of the shell;
a lower surface of the second wall; and
a second portion of the second seal.

13. The reactor according to claim 1, further comprising:
a sensor that is configured to enable measurement of a sensor parameter associated with the isolation zone; and
a controller that is configured to determine process data using a value of the sensor parameter measured using the sensor.

14. The reactor according to claim 13, wherein the controller is configured to transmit a signal in response to a process data value meeting a process criterion.

15. The reactor according to claim 1, further comprising an isolation zone fluid outlet configured to enable fluid to exit the isolation zone.

16. A reactor comprising:
a shell having a feed fluid inlet and a product fluid outlet;
a heating chamber within the shell having a heating fluid inlet and a heating fluid outlet;
a plurality of tubes located within the shell and providing fluid communication between the feed fluid inlet and the product fluid outlet, the plurality of tubes extending through the heating chamber from a fixed end to a free end;
a first boundary in the shell, through which the tubes pass, the first boundary being located between the feed fluid inlet and product fluid outlet and forming one end of the heating chamber;
a second boundary in the shell, through which the tubes pass, the second boundary being located between the first boundary and the product fluid outlet, and on a side of the first boundary outside of the heating chamber;
an isolation zone between the first boundary and the second boundary, through which the tubes pass, the isolation zone being configured to receive a purge fluid; and
a sealing system forming a seal between the tubes and each of the first and second boundaries, the sealing system being configured to accommodate relative movement between the tubes, the first boundary and the second boundary where the sealing system engages the tubes.

17. The reactor according to claim 16, wherein the sealing system comprises, for each tube, a first seal and a second seal, the first seal forming a seal about a first part of that tube adjacent the first boundary, and the second seal forming a seal about a part of that tube adjacent the second boundary.

18. The reactor according to claim 16, further comprising a heat transfer zone fluidically sealed from and in thermal communication with the tubes, wherein heat from a fluid passing through the heat transfer zone is transferred to a feed fluid flowing through the tubes.

19. The reactor according to claim 16, wherein:
the isolation zone is formed by and between the shell, the first and second boundaries and the tubes; and
the reactor further comprises an isolation fluid inlet formed in the shell, the isolation fluid inlet enabling the purge fluid to flow into the isolation zone.

20. The reactor according to claim 16, further comprising a purge fluid in the isolation zone, the purge fluid being at a positive pressure relative to the heat transfer fluid.

21. The reactor according to claim 16, wherein the purge fluid is at a positive pressure relative to a product fluid leaving the shell at the product fluid outlet.

22. The reactor according to claim 16, further comprising a tube sheet that is connected to the shell, and that extends across an inside of the shell;
wherein each tube:
is connected to the tube sheet;
has an inlet opening in fluid communication with the feed fluid inlet and an outlet opening in fluid communication with the product fluid outlet; and
extends away from the tube sheet to a free end.

23. The reactor according to claim 17, wherein:
the first boundary comprises a first wall that is connected to the shell and that extends across the inside of the shell, the first wall defining a plurality of first wall openings, each first wall opening being configured to enable one of the plurality of tubes to extend through the first wall;
the second boundary comprises a second wall that is connected to the shell and that extends across the inside of the shell, the second wall defining a plurality of second wall openings, each second wall opening being configured to enable one of the plurality of tubes to extend through the second wall;
the tube sheet is between the feed fluid inlet and the first boundary; and
the first boundary is between the tube sheet and the second boundary.

24. The reactor according to claim 23, wherein the sealing system comprises:
a first seal that is connected to the first wall at one of the first wall openings, the first seal being configured to contact the tube of the plurality of tubes that extends through the respective first wall opening, to form a seal about a first part of that tube; and
a second seal that is connected to the second wall at one of the second wall openings, the second seal being configured to contact the tube of the plurality of tubes that extends through the respective second wall opening, to form a seal about a second part of that tube.

25. The reactor according to claim 18, wherein:
the first seal is exposed to the heat transfer zone and the isolation zone; and
the second seal is exposed to the isolation zone and an outlet zone of the reactor.

26. The reactor according to claim 22, wherein an inlet zone of the reactor is defined, at least in part, by:
a first end portion of the shell; and
an upper surface of the tube sheet.

27. The reactor according to claim 18, wherein the heat transfer zone is defined, at least in part, by:
an intermediate portion of the shell;
an upper surface of the first boundary; and
a first portion of the first seal.

28. The reactor according to claim 17, wherein an outlet zone of the reactor is defined, at least in part, by:
a second end portion of the shell;
a lower surface of the second boundary; and
a second portion of the second seal.

29. The reactor according to claim 16, further comprising:
a sensor configured to enable measurement of a sensor parameter associated with the isolation zone; and
a controller that is configured to determine process data using a value of the sensor parameter measured using the sensor.

30. The reactor according to claim 29 wherein the controller is configured to transmit a signal in response to a process data value meeting a process criterion.

31. A reactor comprising:
a shell enveloping a plurality of tubes forming a reaction zone adapted for facilitating a reaction, and a heat transfer zone, each of the plurality of tubes provided with open opposite inlet and outlet ends;
the shell provided with a feed fluid inlet in communication with the inlet ends of the tubes, a product fluid outlet in communication with the outlet ends of the tubes, and a fluid impervious wall fluidically isolating, except through the tubes, the inlet from the outlet and the inlet ends from the outlet ends;
a tube sheet extending within and across the shell; and
a wall extending within and across the shell, the wall being spaced apart from the tube sheet, the wall comprising a first wall opening and a second wall opening;
wherein:
the heat transfer zone extends between the tube sheet and the wall;
a tube of the plurality of tubes extends from the heat transfer zone to an intermediate zone of the reactor on an opposing side of the wall from the heat transfer zone, through the first wall opening;
the tube extends from the intermediate zone to the heat transfer zone, through the second wall opening;
the tube comprises at least one bend between the inlet end and the outlet end, in the intermediate zone, the at least one bend defining an intermediate reaction zone portion of the tube;
a catalyst is provided in the tube;
the intermediate reaction zone portion comprises a catalyst-free portion;
the reactor comprises a sealing system that is configured to form a fluid seal between the heat transfer zone and the intermediate zone; and
the reactor is configured such that, in use, a feed fluid fed into the feed fluid inlet flows through the tubes and is heated by a heat transfer fluid flowing through the heat transfer zone and reacts to form a product fluid that flows out of the shell through the product fluid outlet.

32. The reactor according to claim 31, further comprising a baffle located within the shell and forming a fluid impervious barrier between the inlet ends and the outlet ends of the tubes.

33. The reactor according to claim 31, wherein the plurality of tubes are connected to the tube sheet.

34. The reactor according to claim 31, wherein the intermediate zone is between the wall and an interior surface of the shell.

35. The reactor according to claim 31, wherein the at least one bend is on an opposing side of the wall to the tube sheet.

36. The reactor according to claim 31, wherein the first wall opening extends from a first side of the wall to a second side of the wall.

37. The reactor according to claim 31, wherein the second wall opening extends from the first side of the wall to the second side of the wall.

38. The reactor according to claim 31, wherein the sealing system comprises, for each tube, a first seal and a second seal, the first seal forming a seal about a first part of that tube adjacent the wall and the second seal forming a substantial seal about a second part of that tube adjacent the wall, wherein the first part and the second part of the tube are on opposite sides of a common bend of that tube.

39. The reactor according to claim 38, wherein:
each first seal is connected to the wall, and contacts the first part of the respective tube; and
each second seal is connected to the wall and contacts the second part of the respective tube.

40. The reactor according to claim 38, wherein the first seal is exposed to the heat transfer zone and the intermediate zone, and the second seal is exposed to the heat transfer zone and the intermediate zone.

41. The reactor according to claim 31, further comprising:
a sensor configured to enable measurement of a sensor parameter associated with the reactor; and
a controller that is configured to determine process data using a value of the sensor parameter measured using the sensor.

42. The reactor according to claim 41, wherein the controller is configured to transmit a signal in response to a process data value meeting a process criterion.

43. The reactor according to claim 31, wherein the at least one bend of the tube defines at least part of the catalyst-free portion.
